(19) United States
(12) Patent Application Publication
(10) Pub. No.: US 2013/0226959 A1
(43) Pub. Date: Aug. 29, 2013

(54) Method of Storing and Accessing Data in a Database System

(71) Applicants: Jens Dittrich, Saarbrucken (DE); Alekh Jindal, Saarbrucken (DE)

(72) Inventors: Jens Dittrich, Saarbrucken (DE); Alekh Jindal, Saarbrucken (DE)

(73) Assignee: UNIVERSITAT DES SAARLANDES, Saarbrucken (DE)

(21) Appl. No.: 13/821,971

(22) PCT Filed: Sep. 12, 2011
(86) PCT No.: PCT/EP11/65729

§ 371 Date: May 3, 2013

(30) Foreign Application Priority Data
Sep. 10, 2010 (LU) 91726

(51) Int. Cl. G06F 17/30

(52) U.S. Cl. CPC G06F 17/30442
USPC 707/769

(57) ABSTRACT

A method of storing and accessing data in a database system is disclosed. The database system comprises at least one primary data source. The database system is associated with at least one adapted data structure that defines the physical data storage structures (e.g., row storage and columnar storage) in which the data are stored. Data is allocated from the at least one primary data source to the at least one adapted data structure in correlation with a database query received. For example, based on the data access patterns (e.g., queries), the physical data storage structures in which the data managed by the database system are to be stored are dynamically determined.

### FIELD OF THE INVENTION

The present invention relates to a method and system of storing and accessing data in database systems. More particularly it relates to a method and system of storing and accessing data in large relational database systems using adapted data structures (adapted data structures=“storage views”, to call an unknown concept by known terms) in conjunction with a dynamic storage layer.

### BACKGROUND OF THE INVENTION

Traditional relational database systems (RDBMS) use a row-oriented storage system (row store). Examples include Oracle 11g, IBM DB2, and Microsoft SQL Server. In a row store values belonging to the different attributes (columns) of a tuple are stored contiguously on the same data page (e.g. data is stored on consecutive byte regions that are multiples of 1024 Byte). This is beneficial for modifying operations such as insert/delete/update, as those operations only need to access a single page in order to perform the operation. As a consequence, typically only two disk I/O operations need to be performed in order to perform any modifying operation.

A huge drawback of row stores can be seen for read-only queries. Assume a read-only query reading two out of ten attributes of any given table. In that case the RDBMS would ideally only need to access two of the attributes on disk in order to compute the result to the query. However, as the storage system of the database is strictly page-oriented, the RDBMS has to read all pages, even though those pages contain data for all ten attributes, i.e. the data belonging to the other eight attributes that are not required to compute the result to the query are also fetched from disk. This means, a row store needs to read 100% of the data pages.

As a consequence, over the past ten years several companies have proposed RDBMSs using a different type of storage system. It is based on a column store. Examples include Sybase IQ, SAP BI Accelerator, Vertica, and VectorWise. In a column store the values for all rows are stored contiguously on disk per column, i.e. these systems store each column in a separate physical unit. Consider again a read-only query requiring only two out of ten attributes. In order to compute the result to this query in a column store it suffices to read the two files containing the attribute values for these two columns only. This means that a column store does not need to read data belonging to any of the eight remaining columns. As a consequence, if we assume that each attribute has the same width, a column store needs to read only 20% of the data pages.

Their high update costs are a huge drawback of column stores. Assume a new tuple is to be inserted into a table. Then all column files have to be changed individually, i.e. in our example ten random I/O-operations will have to be performed. This is extremely costly when compared to a row store. A second drawback of column stores consists in additional costs to merge (join) attributes from the different files to form a contiguous tuple. These costs may be lowered by applying late materialization (D. Abadi, D. Myers, D. DeWitt, and S. Madden, “Materialization Strategies in a Column-Oriented DBMS”, in ICDE, 2007, incorporated herein by reference in its entirety). However, this does not fully solve the problem. In summary, row stores are beneficial for modifying operations, however, have drawbacks for read operations. Vice versa, column stores are beneficial for read operations; however, they have drawbacks for modifying operations.

Companies typically need to support both scenarios: write-optimized and read-optimized queries. Therefore they keep two different RDBMSs with redundant copies of the data. Keeping two different RDBMSs, row stores and column stores, has a severe drawback: it forces companies to use different RDBMS based on the particular application. It may also force users to copy data from one RDBMS to the other. For instance, it is common practice to keep the up-to-date data (being modified) in a row store. Once every night that data is then copied to a second read-optimized RDBMS using a column store. That RDBMS may then be used for read-only queries. Copying data from one RDBMS to another is costly as it requires database administrators to set up costly ETLpipelines (Extract-Transform-Load). Another drawback of this approach is that the company has to pay database licenses for two different RDBMS products. Another drawback of this approach is that the two RDBMS products are typically provided by two different companies. As a consequence the integration of the two RDBMSs might be difficult as both systems support different subsets of SQL (Structured Query Language).

The problem discussed above has become worse over the past years as companies realized that there might be a third type of RDBMS: a relational data stream management system (RDSMS). Examples include StreamBase, TelegraphCQ, and RealtimeMonitoring. An RDSMS processes an unbounded stream of tuples. Tuples may be delivered by the stream at very high rates. In contrast to an RDBMS, in an RDSMS that data is not stored but rather processed on the fly, i.e. the RDSMS has to decide immediately how to process an incoming tuple when it appears. An RDSMS is beneficial for applications such as monitoring fabrication pipelines, stock trading, and traffic monitoring. However, some of these applications frequently require hybrid queries, i.e. queries that may partially be executed by a RDSMS by inspecting the data stream, and partially by inspecting a RDBMS (a row store or a column store). This leads to several technical problems: first, the query processor of the RDSMS has to be integrated with the one of the RDBMS; second, considerable parts of both systems have to be coded redundantly. All of this has technical drawbacks and leads to extra costs in terms of licensing, system integration, and maintenance costs.

In summary, there exist at least three different types of database systems: first, two types of RDBMS: row stores and column stores. Both systems store the data, and a query retrieves the data from the store. Both types of RDBMS can be viewed as two extremes: they either optimizer for updates or for reads. However, modern database workloads typically have a mixed structure, e.g. they have both modifying and read operations (e.g. as pointed out in the SIGMOD 2009 keynote by the SAP AG founder Hasso Plattner (H. Plattner, “A Common Database Approach for OLTP and OLAP Using an In-Memory Column Database”, in Keynote Talk, SIGMOD, 2009, incorporated herein by reference in its entirety). The third type of system is an RDSMS. It does not store the data but rather computes results to pre-registered queries on the fly. Though an RDSMS does not store data, its functionality often resembles the one used in a RDBMS (be it a row or a column store).

### TECHNICAL PROBLEM TO BE SOLVED

It is therefore an object of the present invention to overcome or alleviate at least some of the drawbacks mentioned above.

### BRIEF SUMMARY OF THE INVENTION

In accordance with the present invention, a method of storing and accessing data in a database system is proposed. The database system comprises at least one primary data source. The database system further comprises at least one adapted data structure. The method further allocates at least some data from the at least one primary data source to the at least one adapted data structure in correlation with a database query received.

The method preferably comprises associating the database system with at least one dynamic storage layer, comprising the at least one adapted data structure.

It is preferred that the structure of the at least primary data source is static, while the structure of the at least one adapted data structure is not static.

The at least one primary data source may be selected from a sequential data structure or a data stream.

The method may further comprise adapting the physical layout of the at least one adapted data structure in correlation with the database query received. The structure of the adapted data structure is dynamically determined during operation.

The method may further comprise selecting the physical layout of the at least one adapted data structure from the group comprising a column storage, a row storage, a log storage, an indexed storage, a partitioned storage.

The method may further comprise determining the database system workload characteristics; and selecting the at least one adapted data structure in accordance with the determined database workload characteristics.

The method may further comprise creating the at least one adapted data structure for a predetermined subset of the data from the primary data structure.

The method may further comprise determining the predetermined subset of the data from a query received by the database system.

The method may further comprise creating at least one log-based data structure in other storage media.

The method may further comprise providing the data with at least one identifier; partitioning the data into different adapted data structures based on the at least one identifier.

The method may further comprise grouping entries for the same data and keeping only the most recent entry.

The method may further comprise using a different physical layout for each adapted data structure.

The method may further comprise splitting at least one adapted data structures into at least two further adapted data structures according to the frequency of access of the data entries.

The method may further comprise providing an index adapted data structure pointing to data entries in the at least one primary data structure, and at least one further adapted data structure.

The method may further comprise implementing access algorithms adapted for optimising access to each class of the adapted data structure.

The method may further comprise
collecting statistics on the current data stored in the different adapted data structures as well as the queries
checking whether the collected statistics have changed when compared to the previously collected statistics; and
if it is detected that the statistics have changed:
   computing at least one alternative configurations for the at least one adapted data structure.
   computing the estimated costs of the alternative configuration;
   measuring the costs of the current adapted data structure configuration;
   determining whether the difference of the current costs minus the alternative costs is greater than a predetermined threshold;
   if the difference is greater than the predetermined threshold:
      transforming the adapted data structure configuration to the alternative adapted data structure configuration;
      and passing the data from the current adapted data structure to the alternative adapted data structure.

The transformation costs for transforming the adapted data structures from the present physical layout to an alternative physical layout may be taken into account in determining whether to transform the adapted data structures from the present physical layout to an alternative physical layout.

The method may further comprise collecting statistics only on the queries that have been executed in a predetermined time window.

The method may further comprise collecting time-related statistics on the queries for time-aware predictive modeling of workloads; determining a predicted time-related workload from the time-related statistics; modifying the adapted data structures in line with the predicted time-related workload.

According to the present invention, there is further provided a computer capable of carrying out the described method. The computer program may preferably comprise computer readable code means, which when run on a computer, causes the computer to carry out the described method. There may further be provided a computer program product comprising a computer-readable medium on which the computer program is stored.

### ADVANTAGES

The invention relates to a method and a system for optimising data access in a data processing system such as database systems or data stream management systems. Specifically, the invention provides a method and system to decrease the amount of data read from and/or written to storage media (e.g. persistent and volatile storage media) in order to compute the result to queries.

As a consequence the method and system increases I/O-efficiency both w.r.t. persistent storage media (e.g. optical drives, hard disks, and flash memory) but also w.r.t. volatile storage media (volatile main memory such as DRAM and the different caches such as L1, L2, and L3). Another consequence of the method may be to reduce the energy-consumption of a data processing system.

### SHORT DESCRIPTION OF THE DRAWINGS

These and other aspects of the invention will now be further described, by way of example only, with reference to the accompanying figures.

FIG. 1 shows the overall architecture of a dynamic storage layer (DSL) in accordance with the present invention. It also shows the adapted data structure optimizer.

FIG. 2(a) is an illustration of a non-optimized database.

FIG. 2(b) depicts bag partitioning with one log-based adapted data structure per table, in accordance with the present invention.

FIG. 2(c) shows key consolidation in accordance with the present invention, wherein different versions of the data are removed.

FIG. 2(d) illustrates adapted data structure transformation using more efficient row-based and columns-based adapted data structures in accordance with the present invention.

FIG. 2(e) depicts per-partition adapted data structures for partitioning data into ‘cold’ and ‘hot’ adapted data structures in accordance with the present invention.

FIG. 2(f) is an illustration of the creation of two index adapted data structures for data in accordance with the present invention.

FIG. 3 shows the Optimizer Monitoring Loop and execution flow of the adapted data structure optimizer.

FIG. 4 shows the adapted data structure lattice re-computation with a method using a stepwise approach.

FIG. 5 (a) shows an example of workload adaptation prior to operator log-pushdown.

FIG. 5 (b) depicts an example of workload adaptation after operator log-pushdown.

FIG. 5 (c) is an illustration of workload adaptation by partial adapted data structures.

FIG. 5 (d) shows an example of workload adaptation by stream transformation.

### OVERVIEW OF THE INVENTION

A method for storage management and access in a data processing system is presented. It allows practitioners to build a data processing system comprising the functionality of three previously separate systems: a relational database management system (RDBMS such as a row store and a column store), as well as a data stream management system (DSMS). The method consists of a fully flexible storage system that is automatically configured using statistics of the current workload. The physical storage layout may be adapted to changing workloads. The invention may use different physical layouts for any subset of the data, i.e. any vertical or horizontal partition as well as any subquery—even if a subquery just returns a single data cell. A dynamic storage layer DSL keeps any subset of the data redundant, using as many copies as possible. The method optimizes response time, throughput, and energy consumption of queries in a data processing system.

It is the objective of the invention to provide a new approach to data access and storage in a data processing system. In contrast to previous approaches such as row, column, hybrid stores and data stream systems, the invention proposes adapted data structures using a physical layout that fully depends on the workload and not on some predetermined decision for a particular physical store and/or layout. Of course, an adapted data structure is characterized by the physical layout of its data on the storage medium (any storage medium may be used, including hard disks, flash disks, caches, DRAM, etc).

It is an objective of the invention to provide a method and a system for optimizing data access in a data processing systems such as an RDBMS providing functionality of both types of RDBMS: a row store and a column store, as well as a data stream management system (DSMS).

Specifically it is an objective of the invention to provide a dynamic storage layer (DSL). The dynamic storage layer DSL adapts the adapted data structures used to the characteristics of the workload. This also holds if the characteristics of the workload change over time. The dynamic storage layer DSL may use different physical layouts for any subset of the data, i.e. any vertical or horizontal partition as well as any subquery—even if a subquery just returns a single data cell. In addition, the dynamic storage layer DSL may keep any subset of the data redundant using as many copies as possible (just limited by the available storage space and update costs). In addition, the dynamic storage layer DSL may decide to not keep some of the data at all.

The present invention comprises four parts: adapted data structures SV, a dynamic storage layer DSL, an adapted data structure optimizer, and a database system.

According to a first aspect of the present invention, the core idea of adapted data structures SV is to store any subset of the data in a particular physical layout (including row, column, or column grouped layouts).

According to a second aspect of the present invention a dynamic storage layer DSL is proposed, dropping the assumption made by previous systems that a database system is developed around a central store (be it a row; column; or a any hybrid store such as PAX (A. Ailamaki, D. J. DeWitt, M. D. Hill, and M. Skounakis, “Weaving Relations for Cache Performance”, in VLDB, 2001, incorporated herein by reference in its entirety) or fractured mirrors (R. Ramamurthy, D. J. DeWitt, and Q. Su, “A Case for Fractured Mirrors”, in VLDB, 2002, also incorporated herein by reference in its entirety).

The dynamic storage layer DSL does not have a fixed store. According to the present invention, all data originates from a primary data source, preferably in the form of a sequential data structure such as a central log (also called a journal), i.e., all insert and update operations create logical log-entries in that log. Alternatively, a data stream may be used as the primary data source. Based on the primary data source, the database system may then define several types of optional adapted data structures. An adapted data structure (SV) represents all or any part of the primary data source in a different (or the same) physical layout. For instance, a row-based adapted data structure RowSV represents all or part of the data from the log in a row store. Here the row store only comprises data belonging to any subset of the data. That RowSV, however, is just one possible adapted data structure. It may dynamically be replaced in the dynamic storage layer DSL by a column-based adapted data structure ColSV if this better suits the characteristics of the workload.

In accordance with the third aspect of the present invention, an adapted data structure optimizer analyses the query plans for incoming queries and also decides on the physical layout of the adapted data structures (storage views). Thus, it comprises functionality belonging to traditional query optimizers but additionally also decides on the physical layout of the adapted data structures (storage views).

According to a fourth aspect of the present invention, a query-processing engine is provided on top of the dynamic storage layer DSL. This may include an optimizer which decides on the adapted data structures to create. This optimizer may either decide fully automatically, or may make proposals, which need to be confirmed by a database administrator. In both cases the dynamic storage layer DSL will then perform the necessary transformations to create the new adapted data structures and transform the data accordingly.

Embodiments of the dynamic storage layer DSL and the database system may be used in different data processing systems including relational data processing systems such as RDBMS and RDSMS. However, other embodiments may include analytical systems such as MapReduce (J. Dean and S. Ghemawat, “Mapreduce: Simplified Data Processing on Large Clusters”, in OSDI, 2004, incorporated herein by reference in its entirety).

Other embodiments may include non-relational data processing systems based on other data models such as XML (Extensible Markup Language), RDF (resource description framework), graphical data, or object-oriented systems.

In other embodiments, the dynamic storage layer DSL may also even keep one part of a table, e.g. old entries that are not updated, in a first adapted data structure Col SV, and another part in a second adapted data structure Row SV, e.g. entries that are still being updated. This emulates a hybrid of row and column stores. In addition, the dynamic storage layer DSL may also replace some of the “tables” by streaming windows, e.g. the dynamic storage layer DSL then emulates a (relational) data stream management system (RDSMS).

In other embodiments, the dynamic storage layer DSL and the database system may also model combinations of streams and store (=archival) queries. As a store, the dynamic storage layer DSL may use any combination of row, columnar or hybrid physical layout to represent any subset of the data. Any subset may be stored redundantly. This includes the use of different physical layouts for different subsets.

In the dynamic storage layer DSL the decision which data to store in which physical layout is done adaptively, transparently, and solely based on the workload (the relational schema of the tables, their statistics, as well as the queries computed by the data processing system)—and not based on some static (design) decision for a concrete database product, which would result in an inflexible, fixed storage layout.

In other embodiments, the dynamic storage layer DSL may also model combinations of streams and store (=archival) queries.

In other embodiments, the dynamic storage layer DSL may use an automatic optimizer to decide which adapted data structures to create for which subset of the data. This means that the physical layout to use for any subset of the data may be decided by an optimizer and not by a database administrator.

In other embodiments, the dynamic storage layer DSL may use an automatic optimizer to make proposals for new physical layouts. A database administrator may then decide which adapted data structures to create for which subset of the data. This means that the physical layout to use for any subset of the data is decided by a database administrator based on suggestions made by an optimizer.

### DETAILED DESCRIPTION OF A PREFERRED EMBODIMENT OF THE INVENTION

In the following we will explain the invention using a running example. However, it is to be understood that this example is merely used for presentation reasons, and thus not intended to limit the scope of the invention. The invention also comprises other embodiments using other scenarios. In general, all scenarios expressible in extended relational algebra are covered by the invention.

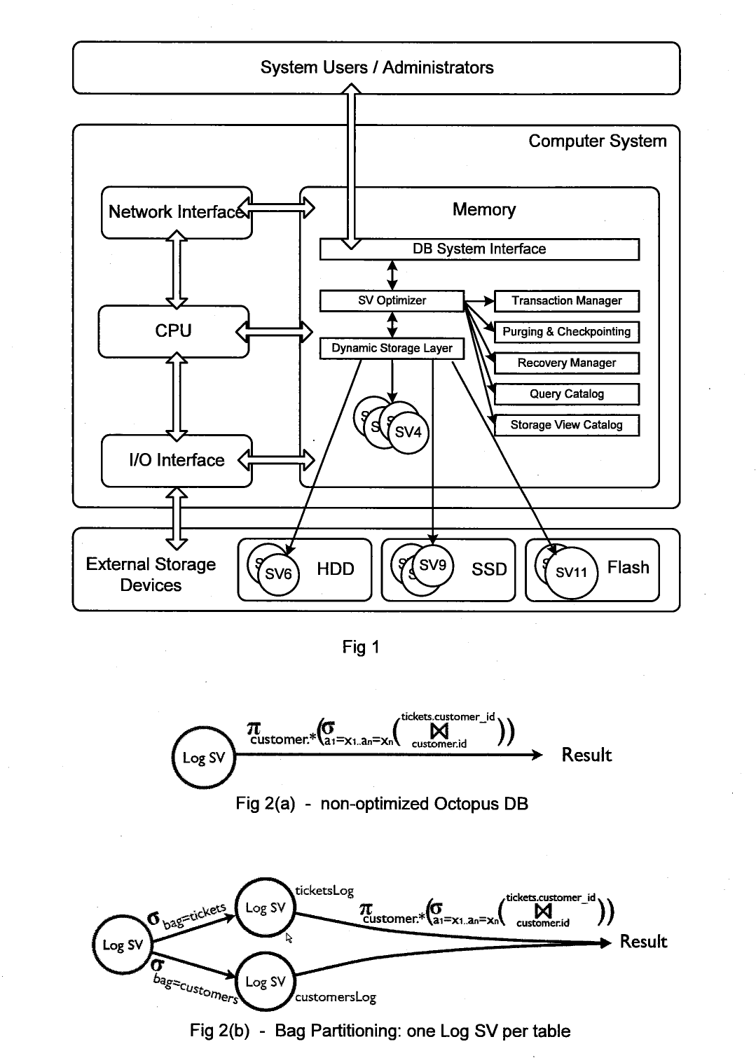

FIG. 1 shows the main components of the dynamic storage layer DSL and the database system in accordance with the present invention. The database system comprises components similar to the ones known from traditional DBMSs (transaction manager, query optimizer, etc.). The most striking difference is the provision of a primary, preferably sequential, data structure Log SV in the form of a primary log store, as well as the provision of an at least one adapted data structure SV in the form of a adapted data structure store.

The data model in accordance with the present invention is as follows. The data items managed by the database are tuples tᵢ=(a₁, . . . , aₙ₍ᵢ₎); 0≦i≦N where attributes a₁, . . . , aₙ₍ᵢ₎ may be of any type. The number of attributes for tuple i is given by n(i). Each tuple is associated to a bag and a key. The bag is used to define subsets of the tuples, e.g. tables, partitions, collections. The key identifies a tuple inside a bag. For simplicity, we assume a relational model throughout the description of the preferred embodiment of the present invention. Therefore all tuples having the same bag share the same set of attributes (=schema). However, this need not be the case in general: a tuple may specify some attributes that are not specified by other tuples with the same bag-identifier.

The database system in accordance with the present invention does not keep a fixed row-, column- or any other store by default. All calls to its system interface are simply recorded in a primary, preferably sequential, data structure called log SV, which is a sequential log, in which appropriate logical log records are created. The primary log SV is itself a data structure.

In accordance with the present invention, the database system stores its primary data structure log SV persistently on durable storage (e.g. hard disk or solid state disk or any future persistent media), preferably following the write-ahead logging-protocol (WAL). For efficiency reasons, it may be preferred that the database system in accordance with the present invention keep a copy of the primary data structure log SV in main memory (or any other future non-persistent media).

Each call to the system interface of the database system in accordance with the present invention internally creates a log record with an associated log sequence number lsn. As in traditional DBMSs log sequence numbers are unique and no two log records may have the same lsn, therefore entries to the log are serialized. For the moment, all log records are logical and represent a new state defined by an operation (in addition, transitional log records may be used, e.g. a=a+42). Therefore, in the database system in accordance with the present invention, and in contrast to ARIES (C. Mohan et al., “ARIES: A Transaction Recovery Method Supporting Fine-Granularity Locking and Partial Rollbacks Using Write-Ahead Logging”, ACM TODS, 17(1): 94-162, 1992, incorporated herein by reference in its entirety) log records do not represent changes that have been or should be applied to a concrete database store. According to the present invention the log simply contains the event history of operations without specifying how these events map to a particular store.

Thus, the format of the log record is (lsn, <method>, <parameters>) where <method> denotes the method of the system interface called and <parameters> denotes the parameters passed. A method may be an entire logical query (e.g. specified in SQL or relational algebra). It may also be a read or write operation to a table, adapted data structure, page or any other storage unit used by the database system in accordance with the present invention.

An example of a preferred embodiment of a system interface is expressed by the following set of system methods:
registerSV(String svID, Type svType<, additional Par>): creates and registers an SV of type svType having a unique identifier svID. Additional parameters may be passed to the adapted data structure (SV).
registerQuery(String queryID, Query Q<, callback>): registers a query having a unique identifier queryID. An additional callback function may be passed.
snapshot(String outputSVID, String queryID): computes the result of the query and materializes it into the output data structure (SV).
maintain(String outputSVID, String queryID): Same as snapshot, however, future updates will be reflected in outputSVID.
drop(String ID): Drops a query or SV from the system.
query(Query Q)→Iterator it: Queries and/or modifies data in OctopusDB as specified in Q.
iterate(String ID)→Iterator it: Returns an iterator over the contents of the given query or SV.

Query definitions may be either an extended relational algebra expression as suggested by S. Chaudhuri and G. Weikum in “Rethinking Database System Architecture: Towards a Self-Tuning RISC-Style Database System”, in VLDB, 2000, incorporated herein by reference in its entirety), SQL, or Pig Latin (C. Olston et al., “Pig Latin: a Not-So-Foreign Language for Data Processing”, in SIGMOD, 2008, incorporated herein by reference in its entirety). In the following, a relational algebraic expression is assumed. In extended relational algebra σ_{P} corresponds to a selection operation (filter out some tuples based on predicate P); π_{A} corresponds to a projection operation (filter out some attributes based on attribute set A); [symbol] JP corresponds to a join operation on two input relations (join tuples from both inputs based on the join predicate JP); Γ_{key} corresponds to a grouping without aggregation (group tuples of the input into groups using key as the grouping key); γ_{f( )} corresponds to an aggregation without grouping, i.e. aggregate groups of tuples using aggregation function f( ) It is important to note that all other operators may be derived from this core set of operators.

According to the present invention, adapted data structures in the form of Storage Views (SV) allow to define arbitrary physical representations on the log. The main idea of an adapted data structure is to store the entire or a subset of the primary data structure log SV, or any other adapted data structure, but using a different physical layout (optionally also keeping the same layout). It is important to note that the adapted data structures always materialize their data. In accordance with the present invention the database system creates a network or lattice of adapted data structure dependencies, which allows to balance, update and query processing costs. The dependency graph between different adapted data structures will be called the adapted data structure lattice. It is similar to the one used in materialized view maintenance (e.g. in data warehouses). However, the adapted data structure lattice is more general as it is not restricted to logical query/relational algebra definitions only, but also comprises the underlying physical storage layout.

By means of example, an interface to an adapted data structure (SV) is expressed as follows in a preferred embodiment:
iterate(String queryID)→Iterator it: Returns the result of the given query as an unordered iterator it. The query must be restricted to data covered by this SV.
iterationCost(String queryID)→Cost c: returns the estimated cost c of the given query. In other words, it estimates the cost of iterate(String queryID).
transformationCost(Type svType)→Cost c: returns the estimated cost c for transforming this SV into svType.

As a working example, consider a flight-booking system with a table TICKETS containing data on flight tickets; and a table CUSTOMERS containing data on customer. Queries select tickets using predicates on different attribute subsets of the table TICKETS. For all selected tickets the user may want to retrieve all attribute values of matching customers. We further assume that the table TICKETS is frequently updated. Thus, index maintenance on the table TICKETS is too expensive. This is a real-world example as recently proposed by P. Unterbrunner et al. in “Predictable Performance for Unpredictable Workloads”, in PVLDB, 2009 (incorporated herein by reference in its entirety). This scenario calls for having a column layout on the table TICKETS and a row layout on the table CUSTOMERS. However, this flexible layout is not supported by current DBMSs. In addition, the high update rate also precludes using fractured mirrors (see A. Ailamaki et al., above).

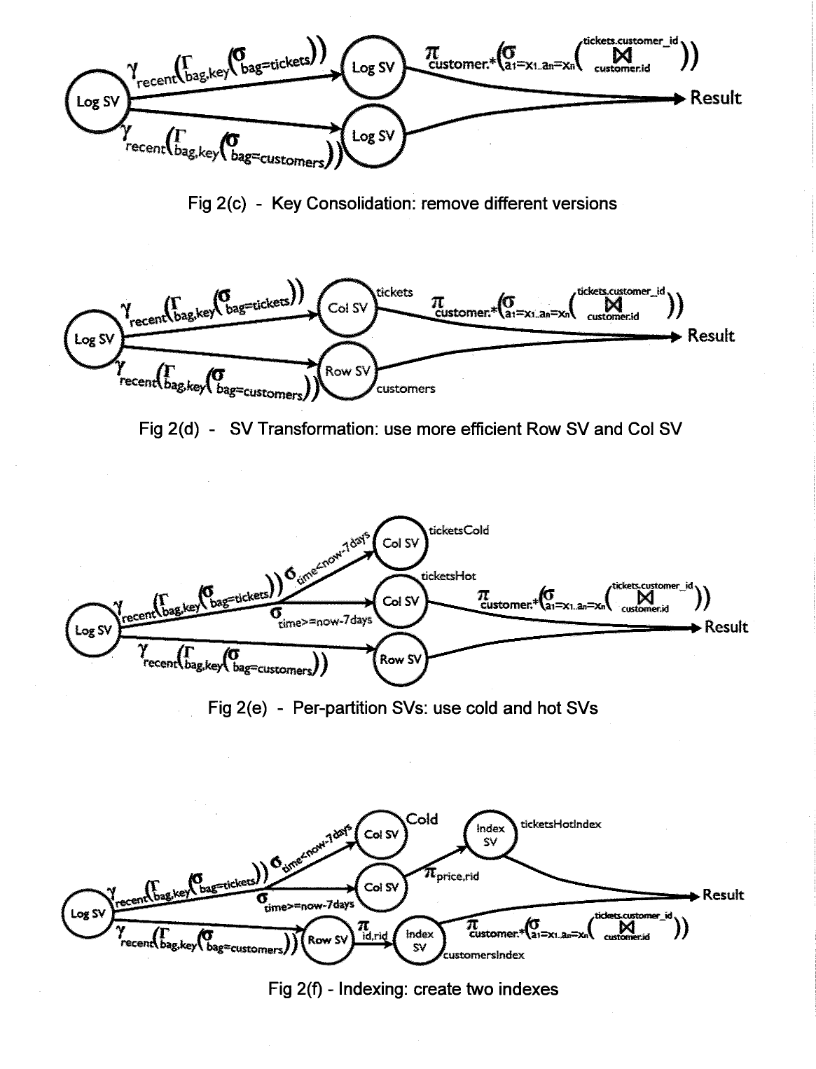

FIG. 2(a) shows a non-optimized database system instance for the Running Example. Initially, the adapted data structure store does not contain any adapted data structures; it only contains a single registered join query. A conventional database could simply evaluate this query by scanning the primary sequential log. However, in accordance with the present invention, the database system may use more efficient methods as explained in detail in the following.

The database system starts with the simplest type of data structure: the log-based data structure Log SV. The primary log store of the database system then simply contains a single Log SV. However, the dynamic storage layer DSL may create further Log SVs in other places.

In the following it is illustrated how the database system and the dynamic storage DSL gradually enrich the adapted data structure lattice of FIG. 2(a).

In the first step the database system will partition the data into different adapted data structures SV based on their bag identifiers. This results in the adapted data structure lattice as depicted in FIG. 2(b). Note that the join query is not connected to the primary data structure Log SV anymore, but to two new adapted data structures Log SV. Thus, the decision how to connect new queries and how to snapshot or maintain adapted data structures is fully up to the system.

Using the outlined system interface, the corresponding sequence of interface calls are expressed as:
registerSV(“ticketsLog”,LogSV);
registerSV(“customersLog”,LogSV);
registerQuery(“customersOnly”,σ_{bag}=customers);
registerQuery(“ticketsOnly”,σ_{bag}=tickets);
maintain(“ticketsLog”,“ticketsOnly”);
maintain(“customersLog”,“customersOnly”);

As the primary data structure Log SV does not discard entries having the same (bag, key)-pair, both adapted data structures ticketLog and customersLog may contain different versions for the same (bag, key)-pair. The database system may preferably group these entries and only keep the most recent one. This results in the adapted data structure lattice as depicted in FIG. 2(c). Both adapted data structures ticketLog and customerLog now only contain the most recent (bag, key)-pairs.

Using the outlined system interface, the corresponding sequence of interface calls are expressed as:
registerQuery(“custRecent”,γrecent(Γ_{bag,key}(customersOnly)));
registerQuery(“tickRecent”,γrecent(Γ_{bag,key}(ticketsOnly)));
maintain(“ticketsLog”,“tickRecent”);
maintain(“customersLog”,“custRecent”);

The adapted data structures may be organized per table. The main idea of a row-based adapted data structure Row SV, respectively column-based adapted data structure Col SV, is to create a row store, respectively column store, for any given subset of the data as specified by a query. Thus, a different physical layout of the data is used. For instance, the scanning costs for the two logical sequential logs ticketLog and customerLog may eventually become too high, e.g. surpassing a given service level agreement (SLA). In that case, the database system may replace these log-based adapted data structures by a column-based adapted data structure Col SV and a row-based adapted data structure Row SV. FIG. 2(d) shows the resulting data structure lattice. In summary, the adapted data structure TICKETS is kept in the same layout as done by a traditional DBMS using a column store. In contrast, the adapted data structure CUSTOMERS is kept in the same layout as done by a traditional DBMS using a row store. Thus, the database system in accordance with the present invention effectively mimics different stores for those tables. Obviously the database system could use a different layout for each “table” being registered. In addition, the database system could also create a row-based adapted data structure Row SV and a column-based adapted data structure Col SV on the same input data structure thus easily mimicking fractured mirrors (see R. Ramamurthy et al., above).

In a further configuration of the present invention, a per-partition adapted data structures may be employed. Assume that some of the rows in adapted data structure TICKETS are accessed more often than others. For instance, users might be considerably more interested in tickets not older than 7 days rather than older tickets. In this case the database system in accordance with the present invention may split the adapted data structure TICKETS into two adapted data structures ticketsCold and ticketsHot as shown in FIG. 2(e). This creates two horizontal partitions using a range partitioning on time. It also faintly resembles buffer management: a database buffer keeps the hot data on a different physical device (advantageously the main memory) than the cold data (for which disk storage may be preferred). The database system may preferably make this decision dependent on the workload.

Using the outlined system interface, the corresponding sequence of interface calls are expressed as:
registerSV(“ticketsCold”, ColSV);
registerSV(“ticketsHot”, ColSV);
registerQuery(“tickRecentHot”,σ_{time≧now}-7 days(tickRecent));
registerQuery(“tickRecentCold”,σ_{time<now}-7 days(tickRecent));
maintain(“ticketsCold”, “tickRecentCold”);
maintain(“ticketsHot”, “tickRecentHot”);
drop(“ticketsLog”);

An adapted data structure in the form of an Index is another configuration of the present invention. The database system may also use any type of index including B+-trees, hash indexes, bitmaps, cache-optimized-trees, Rtrees, inverted indexes, and so forth. This is because indexes are just another type of adapted data structure.

In the running example, and using the outlined system interface, the sequence of interface calls corresponding to build Index data structures over customers and hot tickets is expressed as:
registerSV(“ticketsHotIndex”,IndexSV,uncl,key=price);
registerSV(“customersIndex”,IndexSV,cl,key=id);
registerQuery(“tickI1”,π_{price,rid}(ticketRecentHot));
registerQuery(“custI2”,π→_{ID,rid}(custRecent));
maintain(“ticketsHotIndex”,“tickI1”);
maintain(“customersIndex”,“custI2”);

The adapted data structure Index SV typically uses a subset of the existing attributes to build indexes. In this case an index lookup will point to data in an underlying adapted data structure, e.g. a Row SV. The database system may also create a covering index by copying all attributes to avoid those lookups. Alternatively, the database system may create a clustered index by rearranging the order of tuples in the underlying adapted data structure. The index may also be built on only parts of a table thus mimicking partial indexing (M. Stonebraker, “The Case For Partial Indexes”, SIGMOD Rec., 18(4): 4-11, 1989, incorporated herein by reference in its entirety). Obviously, adding indexes may improve query performance for selective queries. On the downside update costs may increase, as all existing indexes affected by an update have to be maintained. Thus the decision whether to create an index adapted data structure (or any other adapted data structure) will be affected by the query/update pattern of the particular workload.

The adapted data structures can be optimized by an adapted data structure optimizer. In general, each class of adapted data structure may implement its own access algorithms optimized for the particular storage structure. For instance, a row-based adapted data structure RowSV may use row-wise compression and row-oriented iteration, e.g. (A. L. Holloway et al., “How to Barter Bits for Chronons: Compression and Bandwidth Trade Offs for Database Scans”, in SIGMOD, 2007, incorporated herein by reference in its entirety). In contrast, a column-based adapted data structure Co/SV may implement column-oriented compression and vectorized iteration (P. A. Boncz, M. Zukowski, and N. Nes, “MonetDB/X100: Hyper-Pipelining Query Execution”, in CIDR, 2005, incorporated herein by reference in its entirety). Additionally, the database system may push down selections, projections, or entire subplans to the respective adapted data structures. The adapted data structures may then locally use their own optimizer to optimize sub-plans. This has the advantage that query processing techniques optimized for a specific store may be leveraged. Outside those adapted data structures, the database's adapted data structure optimizer may then:

(1) accelerate query processing, i.e. pick the most promising physical execution plan to compute a query;
(2) apply updates to any adapted data structure in the adapted data structure store, i.e. pick the best update method like a batch-oriented differential update or log-structured merge-trees;
(3) decide on the adapted data structure to create and keep in the adapted data structure store, i.e. whether to materialize a new adapted data structure or drop an existing one;
(4) combine results spanning several adapted data structures, e.g. to join data from a row, a column store, and a streaming window. As mentioned above, all these tasks may be generalized into a single task: adapted data structure selection. Therefore, the database system handles these problems using a single adapted data structure optimizer.

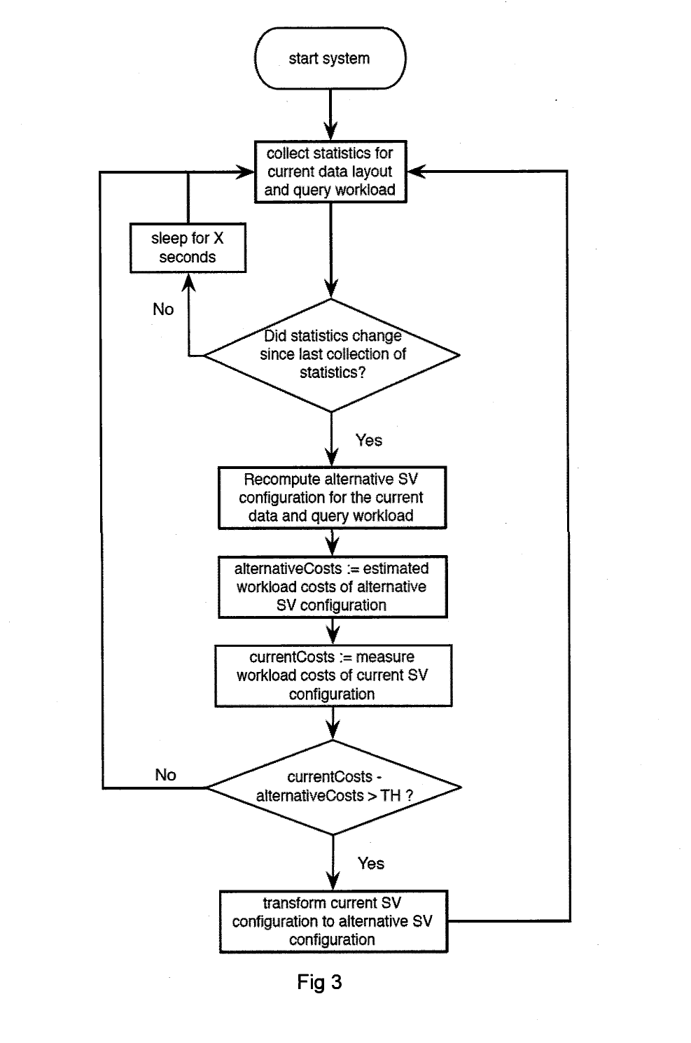

As shown in FIG. 3, an Optimizer Monitoring Loop operates the adapted data structure optimizer. When the system is started, it collects statistics on the current data stored in the different adapted data structures (e.g. data distribution, number of tuples, widths of attributes) as well as the queries that are currently being executed or have been executed in the past (this past may optionally be defined by setting an appropriate time window). Then the optimizer checks whether the collected statistics have changed when compared to the previously collected statistics. If no change is detected, the statistic collection process may sleep for a predefined amount of time, e.g. X seconds. However, if it is detected that the statistics have changed, the optimizer proceeds as follows:

(1) compute alternative configurations of adapted data structures;

Preferably the alternative configurations of the adapted data structures are limited to those that have either already previously been used by the database system, and/or which would correspond to the adapted data structure required by a query recently received

(2) compute the estimated costs of each alternative adapted data structure configuration and assign it to alternativeCosts. Here, costs refer to the workload costs (not the costs to transform one adapted data structure configuration to another);
(3) the optimizer measures the costs of the current adapted data structure configuration and assigns it to currentCosts;
(4) the optimizer checks if currentCosts-alternativeCosts is greater than a given threshold TH;
(5) If that is not the case, the optimizer continues by collecting statistics.

Advantageously, the transformation costs for transforming the adapted data structures from the present adapted data structure to an alternative adapted data structure may be taken into account when determining whether to transform the adapted data structures from the present adapted data structure to an alternative adapted data structure.

Otherwise, i.e. if the difference of the two costs is above the threshold TH, the optimizer will transform the current adapted data structure configuration to the alternative adapted data structure configuration. Eventually the optimizer returns to the monitoring loop and continues by collecting statistics again.

The adapted data structure optimizer uses a cost model to perform the above-mentioned optimizations. The cost model is similar to the one used by existing state-of-the-art cost-based query optimizers. In contrast to the latter, however, in accordance with the present invention the optimizer may also considers transformation costs, i.e. the costs to transform an adapted data structure from one physical layout to another physical layout.

The adapted data structure optimizer can rearrange the adapted data structures in the adapted data structure lattice in order to balance query and update costs. This implies that the adapted data structure optimizer decides how to connect new adapted data structures to the logical adapted data structure lattice. Physically, the arrow depicts a flow of data items, i.e. updates in the adapted data structure lattice are delivered through arrows only. One particular advantage of using an optimizer in accordance with the present invention is that the query operators may be pushed down through the entire adapted data structure store—even beyond the primary log. This is a common scenario in a RDSMS and termed ‘shedding’ (N. Tatbul, U. C [symbol] etintemel, S. Zdonik, M. Cherniack, and M. Stonebraker, “Load Shedding in a Data Stream Manager”, in VLDB, pages 309-320, 2003, incorporated herein by reference in its entirety).

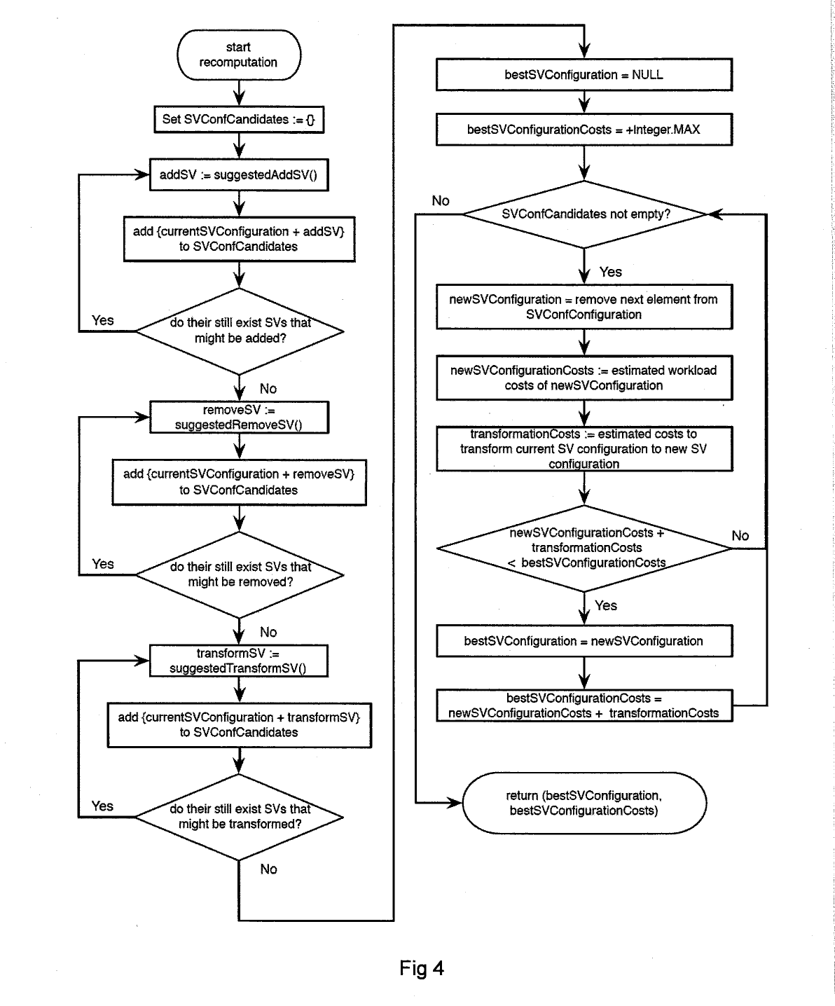

The adapted data structure lattice may be recomputed as follows. At certain points in time (e.g. as outlined in Optimizer Monitoring Loop) the adapted data structure optimizer may search for a better adapted data structure configuration. This works as shown in FIG. 4. Notice that all changes to the adapted data structure lattice—including the ones described in following paragraphs—are computed by this method. The main idea of this method is to consider a change to the adapted data structure lattice. A change may be either:

(1) find an adapted data structure to add to the existing adapted data structure lattice,
(2) find an adapted data structure to remove from the existing adapted data structure lattice, or
(3) find an adapted data structure already existing in the adapted data structure lattice that should be transformed.

The algorithm collects the different choices in a set coined SVConfCandidates. Each adapted data structure configuration is then assessed using the cost model and the current workload. This means that in any case the decision on which adapted data structure to add, remove or transform may be exclusively made on estimated costs. The decision is thus fully automatic. Hence the database system in accordance with the present invention may adapt and optimize the adapted data structure lattice to a given workload. Obviously, an assumption is that the workload shows some stability over time, i.e. the workload as observed in the recent past is considered a fair prediction of the near future.

The method selects the adapted data structure configuration with the lowest estimated costs. Notice, that in this process the optimizer also considers the costs to transform the current adapted data structure configuration to the new adapted data structure configuration. Finally the algorithm returns the best adapted data structure configuration it could find. The algorithm may be generalized to consider k>1 changes to the adapted data structure lattice simultaneously. Other generalizations of this method may include collecting statistics on scheduled workload, i.e. time-aware modeling of workloads.

As an illustration, assume that a company executes a certain set of queries always around 6 pm and a different set of queries at noon. The database system may be generalized to model these time-aware workload schedules. In that case, the database system does not have to wait for the workload to change, i.e. modify the adapted data structure lattice around 6:15 pm after having seen a considerable change to the workload, but rather anticipate the change, i.e. start modifying the adapted data structure lattice around 5:45 pm, because the database system has statistics on a likely workload change at around 6 pm. In other words, the database system may learn a workload pattern.

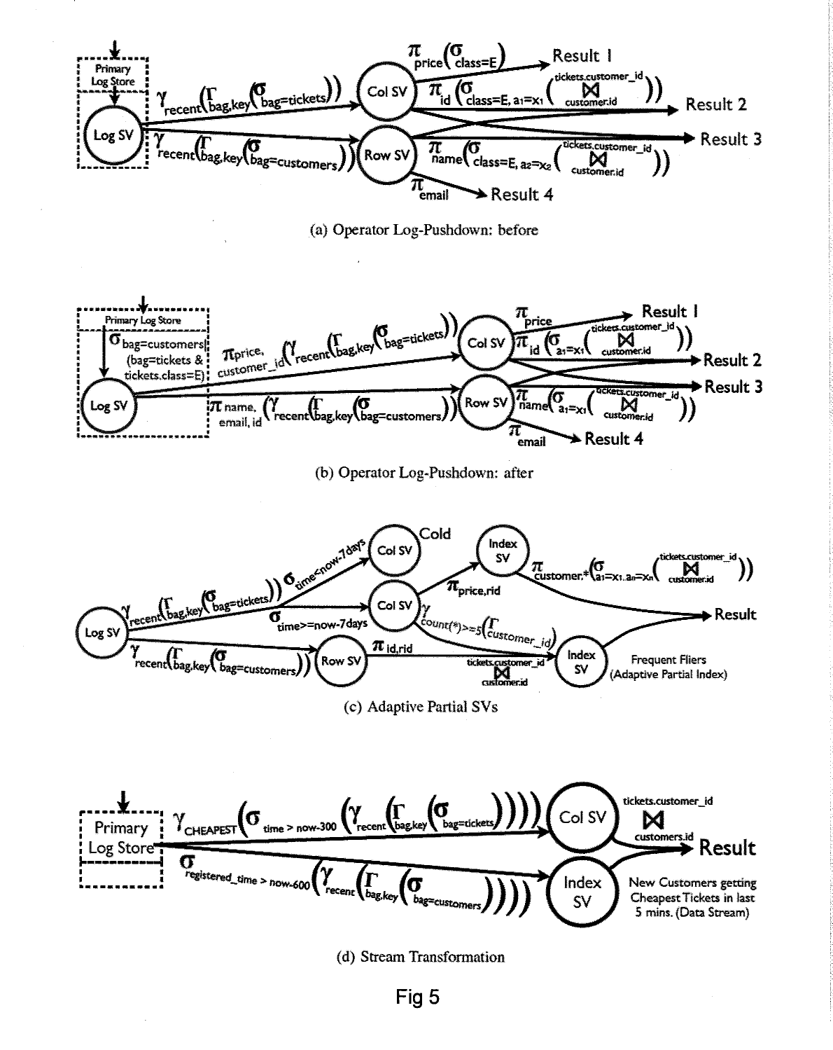

Operator Log-Pushdown is a further option. Adapted data structure lattice recomputation may introduce a variety of changes to an existing adapted data structure lattice. Again, all those changes in the adapted data structure lattice are computed with the method described with reference to FIG. 4. FIG. 5(a) shows an example with four registered queries. All queries are computed based on two adapted data structures only: Col SV and Row SV. In this situation, the optimizer decides to push down some of the selections and projections as follows:

(1) the optimizer examines the projections of all registered queries and computes the union set of attributes, e.g. _price;customer id and _name;email id.
(2) the optimizer pushes these projections down the lattice until the primary data structure Log SV.

Similarly, for selections the optimizer
(1) computes a conjunctive selection, e.g. bag=customersj(bag=tickets&tickets:class=E); and
(2) pushes the conjunctive selection even beyond the primary log.

FIG. 5(b) shows the resulting adapted data structure lattice. This means that any incoming log record will be checked even before putting it into the Log SV in the primary data structure. Tuples not matching will be discarded and thus the database system saves time writing them to the primary log. Obviously, similarly to a store push-down, as soon as a new query comes in, the conjunctive selection may have to be adapted. Otherwise the optimizer would discard relevant data. However in online transaction processing (OLTP) or reporting (not to be confused with online analytical processing, OLAP) workloads are often known (M. Stonebraker et al., “The End of an Architectural Era (It's Time for a Complete Rewrite)”, in VLDB, 2007, incorporated herein by reference in its entirety) and thus a log and pushdown may be an option.

Adaptive Partial data structures may be provided. The adapted data structure optimizer may introduce further adapted data structures to speed-up query processing. Those adapted data structures may be created for those parts of the data that are frequently queried. For instance, it does not make sense to build an index for an entire relation, if only parts of that relation are queries. This observation led to a technique called partial indexing (see M. Stonebraker, above). However, that technique can be extended using the claimed invention to create a partial store adapting dynamically to the current workload. As discussed above, FIG. 2(e) already showed an example for static data structure partitioning. FIG. 5(c) shows an example for adaptive partial adapted data structures. In this example a Frequent Fliers index adapted data structure SV is used. The optimizer uses a join query selecting those customers having at least five tickets over the past week. The Frequent Fliers index adapted data structure will only index those customers. As soon as a customer does not qualify as a frequent flier anymore, the entry will be dropped from the index. Vice versa, if customers qualify, they will be added to the index dynamically.

The primary log may eventually grow too large, especially if the update rate is too high or the database has been up for a while and collected a long log of change operations. In this situation we need to shrink the size of the log. There are several options:
Purging log records for data that is not of interest anymore, e.g. changes older than two years are not needed for OLTP apps.
Compressing the log, thus saving the storage space.
Checkpointing i.e. writing a begin checkpoint log record to the log, creating a storage view for all log records older than the begin checkpoint log record, and finally writing an end checkpoint log record. Purging all log records older than the begin checkpoint log record. Depending on the storage view used for a checkpoint, (a) archiving: using a RowSV or ColSV, (b) aggregating: aggregating part of the log, or (c) re-checkpointing: replacing an existing checkpoint in the log with a derived checkpoint.

Recovery depends on the purging strategy used. For no purging or checkpointing, since the outlined system keeps the primary log on durable storage, simply copy the log from durable storage to main memory and all the data is fully recovered. In the background all adapted data structures that existed before the crash will then be recreated. Note that the recovery process does not have to put any information on the progress information into the log, e.g. like compensation log records. This substantially simplifies the code base of our system. In case the log is purged or checkpointed (i.e. incomplete), we read the log sequentially starting from the oldest entry and collect begin checkpoint log records into a checkpoint set. If we find an end checkpoint log record then we remove the corresponding begin checkpoint from the set. If after reading the log checkpoint is empty, we proceed as if no log purging or checkpointing ever happened. Otherwise we copy the log to main memory, however ignore all checkpoints missing an end checkpoint log record. After copying this partial log, all the data is recovered. After that, in the background we re-create all checkpoints that did not have an end checkpoint log record.

To support concurrent execution of transactions, the system interface can be extended by three methods:
beginTA( )→taID: starts a transaction.
commitTA(taID)→boot: commits transaction.
abortTA(taID)→boot: aborts transaction.

Furthermore, the outlined system interface methods are extended to receive an additional taID parameter. Thus, arbitrary transaction sequences may be defined. As in DBMSs, consistency may be guaranteed by validating a set of integrity constraints at commit time. The Isolation algorithm that is proposed is a variant of the optimistic concurrency control algorithm. Its core idea is to append all changes (uncommitted or committed) to the primary log, but only to propagate committed data to any secondary adapted data structures. Uncommitted transactions can read committed data either from the log or any secondary adapted data structure (SV). They are allowed to write any data object they desire by adding log records to the log, but: the latter modifications are not yet propagated to the secondary adapted data structure. Using this approach Atomicity is trivial as only transactions having a commit log record are reflected in an adapted data structure and need to be considered by other operations.

The same holds for Durability: as mentioned before, the system follows WAL. Since log records are not condensed into a store in the first place (as in current DBMSs), there is no need to undo, redo, before or after images of pages, nor compensation log records to achieve idempotency. Finally, since the update propagation process of adapted data structures is a possible synchronization bottleneck, it could be interesting to improve this to enable eventual or timeline consistency among adapted data structures, i.e. trade consistency for performance.

Finally, stream transformation is considered in the following. In the database system in accordance with the present invention, any incoming log record may correspond to an event or item in a data stream system. For applications having continuous queries, the optimizer may only select a window of interest over the unbounded stream of log records i.e. the primary data source in the database system. This means the “database store” simply consists of several windows of interest. No other (older) data needs to be kept. The database system can achieve this as follows:

(1) do not use a Log SV for the Primary data structure.
(2) route all incoming log records to all relevant queries,
(3) push possible updates up the adapted data structure lattice.

In other words, the optimizer reduces the stream processing problem to an adapted data structure maintenance problem. This means, the database system may decide to not keep a log of incoming data in its Primary Log Store. An example of this is depicted in FIG. 5(d). In this case the database system performs similarly to a DSMS or RDSMS. In the Running Example, suppose the query workload changes to the following query: find new customers (registered within last 10 minutes) having booked the cheapest tickets in the last 5 minutes. For this the database system needs to run a join on two windows. Whenever the content of one of the windows changes, the database system may have to update the result to the join. However, this is not different from adapted data structure maintenance. Thus the database system may use any known technique for updating query results including push-based query directed acyclic graphs (DAG) or batch-oriented (out-of-order) updates (J. Li, K. Tufte, V. Shkapenyuk, V. Papadimos, T. Johnson, and D. Maier, “Out-of-order processing: a new architecture for high-performance stream systems”, PVLDB, 1(1), 2008, incorporated herein by reference in its entirety). Notice that any update to the join result is passed outside to the calling function (or user) by providing an appropriate callback function to when registering queries with the database system in accordance with the present invention.

No doubt many other effective alternatives will occur to the skilled person. It will be understood that the invention is not limited to the described embodiments and encompasses modifications apparent to those skilled in the art lying within the spirit and scope of the claims appended hereto.

1. A method for data storage management and access in a database system, the database system comprising at least one primary data source, the method comprising:
providing at least one adapted data structure (SV), which is capable of representing data in a specific physical layout; and
allocating at least some data from the at least one primary data source to the at least one adapted data structure (SV) in correlation with a database query received.

2. The method according to claim 1, wherein the at least one primary data source is selected from a sequential data structure (Log SV) or a data stream.

3. The method according to claim 1, wherein the method further comprises:
adapting the physical layout of the at least one adapted data structure in correlation with the database query received.

4. The method according to claim 1, wherein the method further comprises:
selecting the physical layout of the at least one adapted data structure from a group comprising a column storage (col SV), a row storage (row SV), a log storage (log SV), an indexed storage (index SV), and a partitioned storage (partitioned SV).

5. The method according to claim 1, wherein the method further comprises:
determining workload characteristics of the database system; and
selecting the at least one adapted data structure in accordance with the determined workload characteristics.

6. The method according to claim 1, wherein the method further comprises:
creating the at least one adapted data structure for a predetermined subset of data from a primary data structure (Log SV).

7. The method according to claim 6, wherein the method further comprises:
determining the predetermined subset of the data from a query received by the database system.

8. The method according to claim 1, wherein the method further comprises:
creating at least one log-based data structure (Log SV) in other storage media.

9. The method according to claim 1, wherein the method further comprises:
providing the data with at least one identifier (bag, key); and
partitioning the data into different adapted data structures (SV) based on the at least one identifier (bag, key).

10. The method according to claim 1, wherein the method further comprises:
grouping entries for the same data and keeping only the most recent entry.

11. The method according to claim 1, wherein the method further comprises:
using a different physical layout for each adapted data structure.

12. The method according to claim 1, wherein the method further comprises:
splitting the at least one adapted data structure (SV) into at least two further adapted data structures according to a frequency of access of data entries.

13. The method according to claim 1, wherein the method further comprises:
providing an index adapted data structure pointing to data entries in at least one primary data structure (Log SV) and at least one further adapted data structure (SV).

14. The method according to claim 1 wherein the method further comprises:
implementing access algorithms adapted for optimizing access to each class of the adapted data structure (SI).

15. The method according to claim 1, wherein the method further comprises:
collecting statistics on current data stored in different adapted data structures (SI) as well as the queries;
checking whether the collected statistics have changed when compared to previously collected statistics; and
if it is detected that the statistics have changed:
computing at least one alternative configuration for the at least one adapted data structure;
computing the estimated costs of the alternative configuration;
measuring the costs of the current adapted data structure configuration; and
determining whether the difference of the current costs minus the alternative costs is greater than a predetermined threshold TH; and
if the difference is greater than the predetermined threshold TH:
transforming the current adapted data structure configuration to the alternative adapted data structure configuration; and
passing the data from the current adapted data structure into the alternative adapted data structure.

16. The method according to claim 15, wherein transformation costs for transforming the current adapted data structure from a present physical layout to an alternative physical layout are taken into account in determining whether to transform the current adapted data structure from the present physical layout to an alternative physical layout.

17. The method according to claim 1, wherein the method further comprises:
collecting statistics only on queries that have been executed in a predetermined time window.

18. The method according to claim 1, wherein the method further comprises:
collecting time-related statistics on queries for time-aware predictive modeling of workloads;
determining a predicted time-related workload from the time-related statistics; and
modifying the adapted data structure in line with the predicted time-related workload.

19. A computer configured with executable program instructions that, in response to execution by the computer, cause the computer to carry out the method according to claim 1.

20. A non-transitory computer-readable storage medium comprising computer-executable code that, in response to execution by a computer, causes the computer to carry out the method according to claim 1.

21. (canceled)
